(19) United States
(12) Patent Application Publication
(10) Pub. No.: US 2004/0106376 A1
(43) Pub. Date: Jun. 3, 2004

(54) Rechargeable interrogation reader device and method

(76) Inventor: Ian J. Forster, Essex (GB)

Correspondence Address: WITHROW & TERRANOVA, P.L.L.C., P.O. BOX 1287, CARY, NC, 27512, US

(21) Appl. No.: 10/422,633

(22) Filed: Apr. 24, 2003

Related U.S. Application Data
(60) Provisional application No. 60/375,219, filed on Apr. 24, 2002.

(51) Int. Cl. G08B 26/00

(52) U.S. Cl. 455/41.2; 340/505

(57) ABSTRACT

The present invention relates to a rechargeable transmission device that is coupled to a rechargeable energy source for power. The transmission device communicates with wireless communication devices attached to objects and/or goods to retrieve identification, tracking and other information about the objects. The transmission device is attached to a moveable member that is adapted to carry objects containing wireless communication devices so that the transmission device is aligned with the objects for communication purposes. A recharging unit is attached to the moveable member to form an energy coupling with a power source unit attached to a static member of the transportation device. The power source unit and the recharging unit form a contactless recharging device to recharge the rechargeable interrogation reader when the recharging unit is moved adjacent to power source unit.

### RELATED APPLICATION

This application claims priority and the benefit of U.S. Provisional Patent Application Serial Number 60/375,219 filed Apr. 24, 2002, which is incorporated by reference herein in its entirety.

### FIELD OF THE INVENTION

The present invention relates to a rechargeable interrogation reader that communicates with wireless communication devices for transfer of information.

### BACKGROUND OF THE INVENTION

It is commonplace to track goods, objects and other articles of manufacture during the manufacturing and distribution process. It is also commonplace to provide communication systems for retrieval of information about goods, such as their identification number, expiration date, “born on” date, lot number, and the like. Some communication systems employ optical technology, like a bar code label and scanner, to track and communicate information concerning goods. For example, bar code labels may be placed on the goods, and optical readers may be placed along the route of the goods in the manufacturing and distribution supply chain to read the bar code labels for identification and tracking of the goods.

Some manufacturers have moved from optical systems to radio-frequency systems for tracking and identification of goods. Radio-frequency systems communicate identification and tracking information through radio-frequency communication signals as opposed to light signals used in optical systems. Radio-frequency systems are not dependent on the same obstacles that are present in optical systems, such as line of sight communications, label integrity, and environmental light interferences.

Some manufacturing and distribution facilities use transportation systems, such as a forklift truck, to transport and/or store goods. These goods are often stacked on objects known as “pallets” for transport. If a wireless communication device is placed on goods and/or pallets, a transmitter, such as an interrogation reader, can track and communicate with the goods and/or pallets. Interrogation readers are normally placed on the manufacturing floor in the possible transportation paths of the goods to ensure that all of the goods are identified.

One tracking and information system is disclosed in pending application Ser. No. 09/810,858, entitled “Communicating with stackable objects using an antenna array,” and assigned to the same party as the assignee of the present application. This application discloses an interrogation reader that is attached to the moveable member of a transportation device. The interrogation reader communicates with wireless communication devices on the goods and/or pallets. The moveable member raises and lowers to raise and lower goods during their storage and retrieval from storage facilities. This allows less interrogation readers to be placed in the manufacturing facility since goods are transported on transportation devices at some time during their manufacture and/or distribution.

The interrogation reader must have a power source to operate. The interrogation reader may be attached to the same power system that provides power to the transportation device, such as the battery or engine of the transportation device. However, if the interrogation reader is attached to a moveable member of a transportation device that moves relative to the transportation system's power source, the design must provide flexible coupling between the interrogation reader and the power source. Such flexible couplings are cumbersome in that they may develop drag and/or be damaged or severed by environmental objects during movement of the transportation device.

One solution to this problem is to provide a rechargeable energy source for the interrogation reader. The rechargeable energy source is periodically recharged and provides power to the interrogation reader. However, like the problem of coupling the interrogation reader to the transportation system's power source, the interrogation reader must also be coupled to a power source for recharging.

Therefore, there exists a need to provide a charging system for an interrogation reader having a rechargeable energy source that does not require physical coupling to a power source.

### SUMMARY OF THE INVENTION

The present invention is directed to a device, system and method of recharging a rechargeable interrogation reader. The rechargeable interrogation reader is placed on a moveable member of a transportation device that transports goods or other stackable objects, such as pallets, containing articles having a wireless communication device. The moveable member moves relative to the transportation device to raise and lower goods. These goods may be placed on pallets which are raised and lowered by the transportation device for transport and/or storage.

A power source unit is attached to a static portion of the transportation device. A moveable arm on the transportation device contains an energy-receiving device that is coupled to the rechargeable energy source in the rechargeable interrogation reader. When the energy-receiving device is placed adjacent to the power source unit, power is transferred from the power source unit to the energy-receiving device to recharge the rechargeable energy source in a contactless manner.

In one embodiment, the power source unit emits an AC power signal that is connected to a primary coil in the power source unit to create an inductive field. A recharging unit having a secondary coil is attached to the moveable portion of the transportation device. When the moveable portion of the transportation device is positioned such that the recharging unit is adjacent to the power source unit, the field from the primary coil induces a current on the secondary coil. This inductive field causes a current to be induced on the secondary coil that is then coupled to a rectifier and rechargeable energy source in the rechargeable interrogation reader for recharging.

In an alternative embodiment, the power signal from the power source unit is connected to one half of a capacitor to create an electric field. A recharging unit having the second half of the capacitor is attached to the moveable portion of the transportation device. The electric field between the moveable portion and the first half of the capacitor causes a voltage to be induced that is then coupled to the rechargeable energy source in the rechargeable interrogation reader for recharging.

The control system in the rechargeable interrogation reader is adapted to control recharging in one embodiment of the present invention. The control system is coupled to a switch that is placed between the rectified signal from the recharging unit and the input to the rechargeable energy source. If the control system activates the switch, the signal is coupled to the rechargeable energy source for recharging. If the switch is deactivated by the control system, the signal is decoupled from the rechargeable energy source to discontinue recharging.

The rechargeable interrogation reader may communicate any error condition, inoperability, or communication information concerning the goods and/or stackable objects to another system located in close proximity to the interrogation reader, or to a remote system, or both.

### BRIEF DESCRIPTION OF THE DRAWINGS

FIG. 1 is a schematic diagram of a rechargeable interrogation reader and wireless communication device system in the prior art;

FIG. 2 is a schematic diagram of a forklift truck that has a rechargeable interrogation reader and transports goods having wireless communications devices stacked on pallets;

FIG. 3 is a schematic diagram of a forklift arm having a primary coil and a secondary coil located adjacent each other to form a transformer for recharging the rechargeable interrogation reader;

FIG. 4 is a schematic diagram of the transformer and rectifier circuit for recharging the rechargeable energy source;

FIG. 5 is a schematic diagram of a capacitor and rectifier circuit for recharging the rechargeable energy source;

FIG. 6 is a schematic diagram of a rechargeable interrogation reader and switch to activate and deactivate the recharging of the rechargeable energy source;

FIG. 7 is a flowchart diagram of a process for activating and deactivating the recharging of the rechargeable energy source in a rechargeable interrogation reader; and

FIG. 8 is a schematic diagram of an error reporting system.

### DETAILED DESCRIPTION OF THE INVENTION

The present invention is directed to a device, system and method of recharging a transmission device, such as an interrogation reader, that is attached to a moveable member of a transportation device. The transportation device transports stackable objects and/or goods that contain wireless communication devices to communicate information to the interrogation reader.

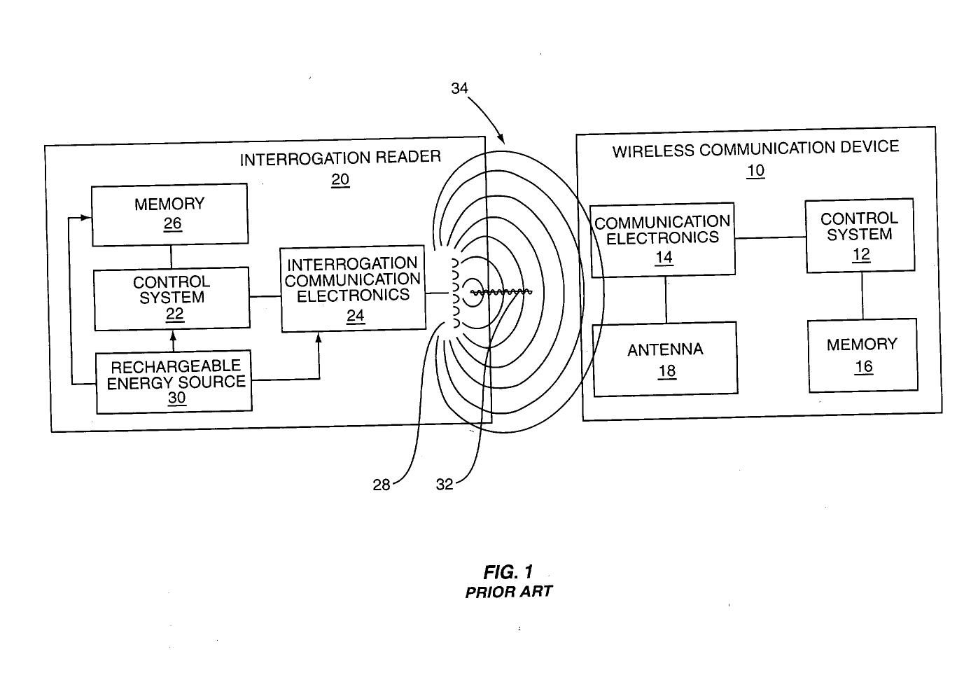

Referring now to the drawings in general, and to FIG. 1 in particular, it will be understood that the illustrations are for the purpose of describing specific embodiments of the present invention and are not intended to limit the invention thereto. FIG. 1 illustrates a typical wireless communication device 10 and communication system in the prior art. The wireless communication device 10 is capable of communicating information wirelessly and may include a control system 12, communication electronics 14, and memory 16. The wireless communication device 10 is also known as a radio-frequency identification device (RFID). The communication electronics 14 is coupled to an antenna 18 for wirelessly communicating information in radio-frequency signals. The communication electronics 14 is capable of receiving modulated radio-frequency signals 32 through the antenna 18 and demodulating these signals 32 into information passed to the control system 12. The antenna 18 may be internal or external to the wireless communication device 10.

The control system 12 may be any type of circuitry or processor that receives and processes information received by the communication electronics 14, including a micro-controller or microprocessor. The wireless communication device 10 may also contain a memory 16 for storage of information. Such information may be any type of information about goods or stackable objects, including but not limited to identification, tracking and other pertinent information. The memory 16 may be electronic memory, such as random access memory (RAM), read-only memory (ROM), flash memory, diode, etc., or the memory 16 may be mechanical memory, such as a switch, dip-switch, etc.

Some wireless communication devices 10 are termed “active” devices in that they receive and transmit data using their own energy source coupled to the wireless communication device 10. A wireless communication device may use a battery for power as described in U.S. Pat. No. 6,130,602 entitled “Radio frequency data communications device,” or may use other forms of energy, such as a capacitor as described in U.S. Pat. No. 5,833,603, entitled “Implantable biosensing transponder.” Both of the preceding patents are incorporated herein by reference in their entirety.

Other wireless communication devices 10 are termed “passive” devices, meaning that they do not actively transmit and therefore may need their own energy source for power. One type of passive wireless communication device 10 is known as a “transponder.” A transponder effectively transmits information by reflecting back a received signal from an external communication device, such as an interrogation reader. An example of a transponder is disclosed in U.S. Pat. No. 5,347,280, entitled “Frequency diversity transponder arrangement,” incorporated herein by reference in its entirety. Another example of a transponder is described in co-pending U.S. patent application Ser. No. 09/678,271, entitled “Wireless communication device and method,” incorporated herein by reference in its entirety.

FIG. 1 depicts typical communication between a wireless communication device 10 and a rechargeable interrogation reader 20. The rechargeable interrogation reader 20 may include a control system 22, an interrogation communication electronics 24, memory 26, and an interrogation antenna 28. The interrogation antenna 28 may be a pole antenna or a slot antenna. The rechargeable interrogation reader 20 has a rechargeable energy source 30 that provides power for operation. The rechargeable energy source 30 may be any type of rechargeable energy device including, but not limited to, rechargeable batteries or a capacitor.

The rechargeable interrogation reader 20 communicates with the wireless communication device 10 by emitting an electronic signal 32 modulated by the interrogation communication electronics 24 through the interrogation antenna 28. The interrogation antenna 28 may be any type of antenna that can radiate the signal 32 through a field 34 so that a reception device, such as a wireless communication device 10, can receive the signal 32 through its own antenna 18. The field 34 may be electromagnetic, magnetic, or electric. The signal 32 may be a message containing information and/or a specific request for the wireless communication device 10 to perform a task or communicate back information. When the antenna 18 is in the presence of the field 34 emitted by the rechargeable interrogation reader 20, the communication electronics 14 are energized by the energy in the signal 32, thereby energizing the wireless communication device 10. The wireless communication device 10 remains energized so long as its antenna 18 is in the field 34 of the rechargeable interrogation reader 20. The communication electronics 14 demodulates the signal 32 and sends the message containing information and/or request to the control system 12 for appropriate actions.

It is readily understood to one of ordinary skill in the art that there are many other types of wireless communications devices and communication techniques than those described herein, and the present invention is not limited to a particular type of wireless communication device, technique or method.

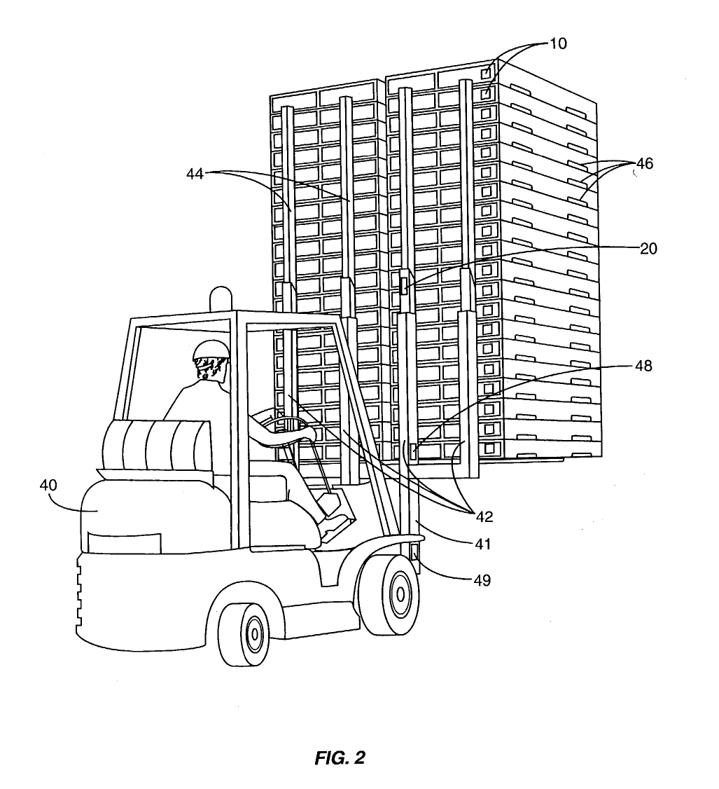

FIG. 2 illustrates one type of transportation device known as a forklift truck 40. The forklift truck 40 is often used to transport and store stacked objects commonly known as pallets 46. Goods are typically placed on the pallets 46 for transport and/or storage. The forklift truck 40 contains members 42, 44, also known as “arms,” that carry the pallets 46. A static member or static arm 42 is fixed rigidly to the body 41 of the forklift truck 40. A second, moveable member or moveable arm 44 is attached to the static arm 42. The moveable arm 44 may be controlled by the forklift truck 40 to move with respect to the static arm 42 for raising and lowering objects contained on the moveable arm 44. Pallets 46 may be stacked on the moveable arm 44 and may be raised or lowered for storage and/or retrieval of goods. The static arm 42 may be comprised of more than a single arm, and the moveable arm 44 may be comprised of more than a single arm depending on the size and characteristics of the forklift truck 40. The forklift truck 40 illustrated in FIG. 2 contains four static arms 42 and four moveable arms 44 for lowering and raising the pallets 46.

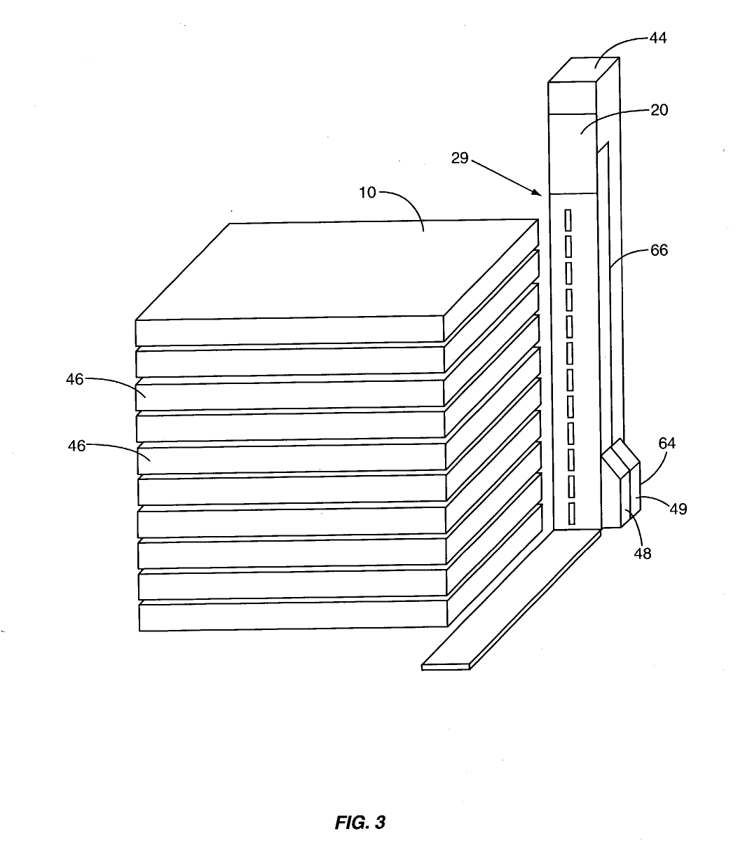

The forklift truck 40 also contains a rechargeable interrogation reader 20 for communication with individual wireless communication devices 10 on the pallets 46 and/or goods on the pallets 46. The rechargeable interrogation reader 20 may be coupled to an antenna array 29 (illustrated in FIG. 3) that contains individual antennas 28 (not shown). The antennas 28 may be placed in the same direction as the pallets 46 are stacked on the moveable arm 44 so that each antenna 28 is located adjacent to the stacked pallets 46. In this manner, the rechargeable interrogation reader 20 may individually communicate with pallets 46 stacked on the moveable arm 44. The advantages of using an antenna array 29 are discussed in pending U.S. patent application Ser. No. 09/810,858 entitled “Communicating with stackable objects using an antenna array,” filed on Mar. 16, 2001, which is assigned to the same assignee as the present invention and is incorporated herein by reference in its entirety.

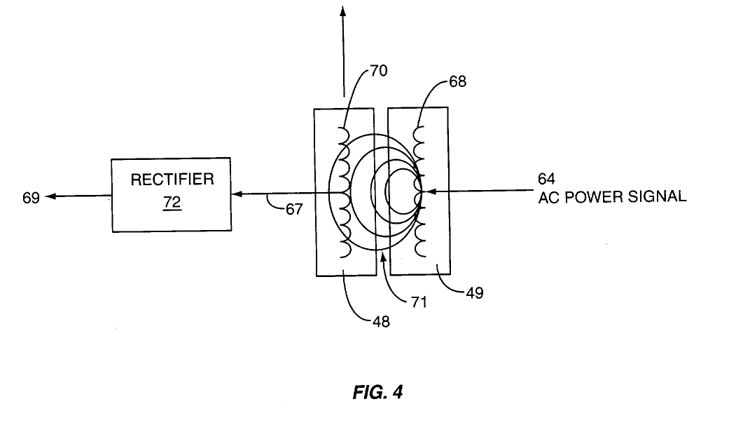

The rechargeable interrogation reader 20 is attached on the moveable arm 44 so that it moves along with the antenna array 29 when the moveable arm 44 is raised or lowered. A recharging unit 48 is also attached to the moveable arm 44. The recharging unit 48 is adapted to recharge the rechargeable energy source 30 when the recharging unit 48 is located adjacent a power source unit 49 attached to the static arm 42. The recharging unit 48 and power source unit 49 may be a coil, capacitor or other device that allows the contactless transfer of energy from the power source unit 49 to the recharging unit 48. The recharging aspects of the present invention are discussed in more detail below in FIGS. 3 and 4.

FIG. 3 illustrates a more detailed view of the moveable arm 44 containing the rechargeable interrogation reader 20, the recharging unit 48, and the power source unit 49. The moveable arm 44 is L-shaped and has an upper section 52 and a lower section 54. Pallets 46 are stacked onto the moveable arm 44 and are raised and lowered by the forklift truck 40.

The recharging unit 48 is coupled to the rechargeable interrogation reader 20 using a conductive connection 66. The conductive connection 66 may be a copper wire, coaxial cable, or other coupling device. The recharging unit 48 receives energy from a power source unit 49 when the recharging unit 48 and power source unit 49 are placed adjacent to each other to form a transformer. Since the recharging unit 48 raises and lowers with the raising and lowering of the moveable arm 44, the recharging unit 48 only receives energy from the power source unit 49 when the moveable arm 44 is in a lowered position in this particular embodiment. In this manner, no physical connection is required between the recharging unit 48 and the power source unit 49 for recharging. The moveable arm 44 containing the rechargeable interrogation reader 20 does not require a physical connection to the power source unit 49 for recharging and thus the moveable arm 44 can move without hindrance. However, the recharging unit 48 and power source unit 49 may be placed at other locations on the moveable arm 44 and static arm 42 respectively so that recharging of the recharging unit 48 occurs when the moveable arm 44 is in a position other than lowered position.

FIG. 4 illustrates a more detailed view of one embodiment of the recharging unit 48 and the power source unit 49. The power source unit 49 contains a primary coil 68 that is coupled to an alternating-current (AC) power signal 64. The AC power signal 64 may be supplied by a power system onboard the forklift truck 40, such as by its battery, engine, or other source. The AC power signal 64 may be 120 Volts or other appropriate voltage so long as it is an AC signal; otherwise the primary coil 68 will not generate the inductive field 71. When the AC power signal 64 is applied to a primary coil 68 in the power source unit 49, the inductive field 71 is generated that reaches a secondary coil 70 in the recharging unit 48. The field 71 induces a current 67 on the secondary coil 70 thereby forming a transformer. The current 67 is still an AC signal, but may be the same, less or greater in voltage than the AC power signal 64 depending on the ratio of turns between the primary coil 68 and the secondary coil 70. The current 67 is rectified by a rectifier 72 to convert the current 67 into a direct current (DC) signal 69. The DC signal 69 is coupled to the rechargeable energy source 30 to recharge the rechargeable energy source 30.

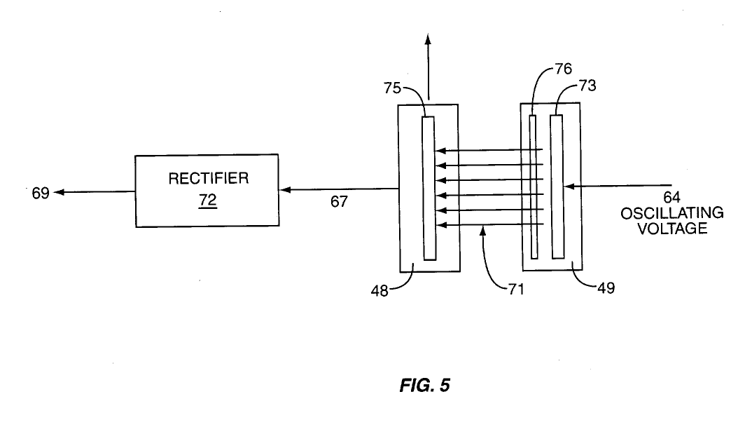

In an alternative embodiment illustrated in FIG. 5, an electric field 71, rather than an inductive field, is used to transfer power from the power source unit 49 to the recharging unit 48. One half of a capacitor or a first plate 73 is contained in the power source unit 49. The other half of the capacitor or second plate 75 is contained in the recharging unit 48. A thin material 76 with a high dielectric constant is placed either on the recharging unit 48 or the power source unit 49 and between the capacitor plates 73, 75. The power source unit 49 emits an oscillating voltage power signal 64 to the first plate 73 of the capacitor, and a charge is created in the capacitor when the recharging unit 48 and the power source unit 49 are placed adjacent to each other. The charge in the capacitor is used to recharge the rechargeable energy source 30 in the rechargeable interrogation reader 20. The current 67 is rectified by a rectifier 72 to convert the current 67 into a direct current (DC) signal 69. The DC signal 69 is coupled to the rechargeable energy source 30 to recharge the rechargeable energy source 30. In this embodiment, recharging occurs when the recharging unit 48 is placed adjacent the power source unit 49 to form a capacitor.

The power source unit 49 may also be capable of sensing the presence of the recharging unit 48 to conserve power. The power source unit 49 detects when the recharging unit 48 is located adjacent as previously discussed above. The power source unit 49 may include a proximity sensor (not shown) or other device to detect the presence of the recharging unit 48. If the recharging unit 48 is not located adjacent to the power source unit 49, the power source unit 49 does not couple the power signal 64 to the primary coil 68 or capacitor plate 73, depending on the configuration, to form the field 71. In this manner, the power source unit 49 only produces the field 71 when the recharging unit 48 is present so that the power source unit 49 may conserve power.

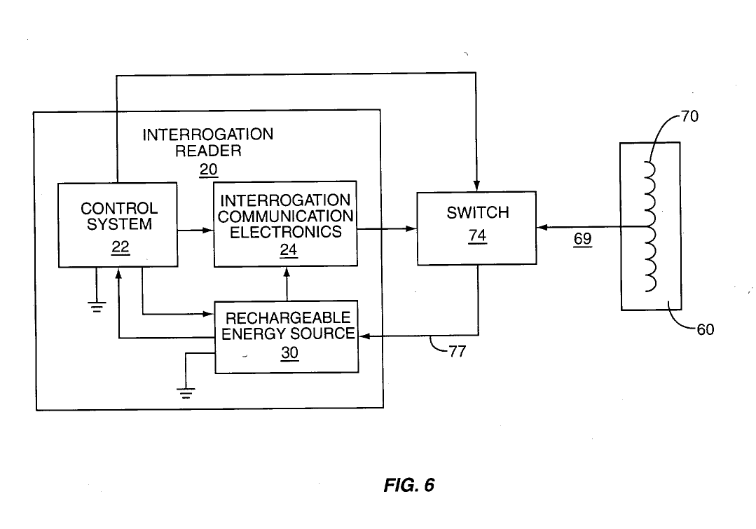

FIG. 6 illustrates an embodiment of the invention whereby the control system 22 in the rechargeable interrogation reader 20 controls recharging of the rechargeable energy source 30. The DC signal 69 is inputted into a switch 74 under control of the control system 22. The switch 74 may be any type of switch that may be controllable by a signal from the control system 22. If the control system 22 desires to recharge the rechargeable energy source 30, the control system 22 activates the switch 74 thereby coupling the DC signal 69 to the input 77 of the rechargeable energy source 30. The control system 22 may disable recharging of the rechargeable energy source 30 by deactivating the switch 74 thereby decoupling the DC signal 69 from the input 77 of the rechargeable energy source 30.

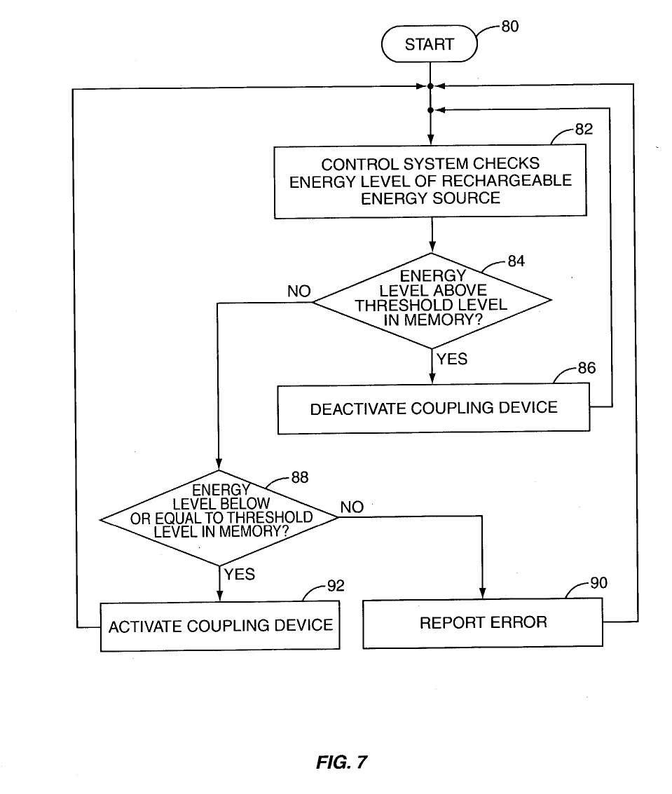

FIG. 7 illustrates a flowchart of one embodiment of the control system 22 controlling the switch 74 in FIG. 6 based on the energy level of the rechargeable energy source 30. For example, if the rechargeable energy source 30 has an energy level above a certain threshold level, the control system 22 may deactivate the switch 74 to discontinue recharging so that the rechargeable energy source 30 is not overcharged. If the rechargeable energy source 30 has an energy level below a certain threshold level, the control system 22 may activate the switch 74 to allow recharging of the rechargeable energy source 30. One embodiment of this process is described as follows.

The process starts (block 80), and the control system 22 measures the energy level in the rechargeable energy source 30 (block 82). If the energy level is above a threshold level stored in memory 26 or indicates a full charge (decision 84), the control system 22 deactivates the switch 74 to decouple the DC signal 69 from the input 77 of the rechargeable energy source 30 to discontinue recharging (block 86). The process repeats by the control system 22 rechecking the energy level of the rechargeable energy source 30 (block 82).

Eventually, the energy level of the rechargeable energy source 30 may drop below the defined threshold energy level stored in memory 26 or below a full charge. When this occurs (decision 84), the control system 22 determines if the energy level of the rechargeable energy source 30 is less than or equal to the threshold energy level in memory 26 (decision 88). If so, the control system 22 activates the switch 74 to couple the DC signal 69 to the input 77 of the rechargeable energy source 30 to again allow recharging (block 92) and the process then repeats (block 82). If the energy level of the rechargeable energy source 30 is not less than or equal to the threshold energy level stored in memory 26, an error is present since the energy level of the rechargeable energy source 30 must either be above the threshold energy level stored in memory 26 or equal to or below the threshold energy level stored in memory 26. This error may have resulted due to a malfunction in the control system 22, memory 26 or some other problem in the rechargeable interrogation reader 20. This error is reported (block 90), and the process repeats (block 82).

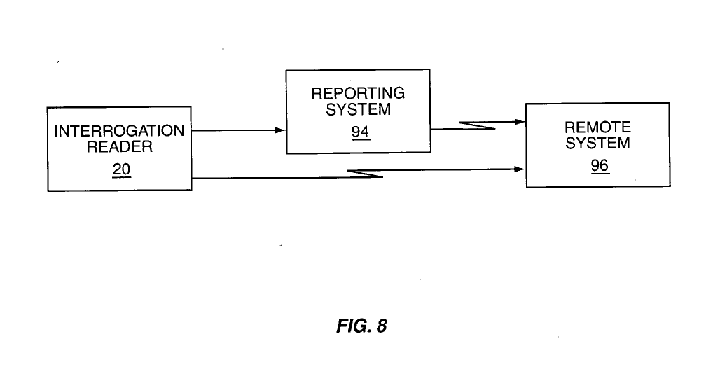

If an error was reported in the process in FIG. 7 (block 90), the error may be reported in several manners. FIG. 8 illustrates a block diagram of error reporting for one embodiment of the present invention. The rechargeable interrogation reader 20 may be coupled to a reporting system 94. This reporting system 94 may be located in close proximity to the rechargeable interrogation reader 20 and may be coupled to the rechargeable interrogation reader 20 by either a wired or wireless connection. The reporting system 94 may be a user interface or other computer system that is capable of recording and indicating an error condition.

The reporting system 94 may also report the error condition to a remote system 96 located remotely from the reporting system 94 and/or the rechargeable interrogation reader 20. The communication between the reporting system 94 and the remote system 96 may be through wired communication, modem communication or other networking communication, such as the Internet. Alternatively, the rechargeable interrogation reader 20 may communicate the error condition directly to the remote system 96 rather than first reporting the error condition through the reporting system 94 using the same or similar communications as may be used between the reporting system 94 and the remote system 96. Also note that the rechargeable interrogation reader 20 may additionally communicate information to the reporting system 94 and the remote system 96 even if an error condition is not present.

Certain modifications and improvements will occur to those skilled in the art upon a reading of the foregoing description. It should be understood that the present invention is not limited to any particular type of component including, but not limited to, the wireless communication device 10 and its components, interrogation reader 20 and its components, arms 42, 44, stackable objects including pallets 46, recharging unit 48, power source unit 49, primary coil 68, secondary coil 70, rectifier 72, and switch 74, etc. Any type of stackable object 46 may be used with the present invention including pallets, objects, etc. Any type of transportation device 40 may be used with the present invention, including a forklift truck and a crane, so long as the transportation device has a moveable member for transport and/or stacking of objects. Power and energy may be used interchangeably with the present invention, and the present invention is not limited to only power or energy in any embodiment if only one of these terms is used. For the purposes of this application, couple, coupled, or coupling is defined as either a direct connection or a reactive coupling. Reactive coupling is defined as either capacitive or inductive coupling.

One of ordinary skill in the art will recognize that there are different manners in which these elements can provide to accomplish the present invention. The present invention is intended to cover what is claimed and any equivalents. The specific embodiments used herein are to aid in the understanding of the present invention, and should not be used to limit the scope of the invention in a manner narrower than the claims and their equivalents.

What we claim is:

1. A rechargeable interrogation reader that is adapted to recharge its energy source from a primary coil, comprising:
a communication electronics;
a rechargeable energy source coupled to said communication electronics to provide power to said communication electronics; and
a secondary coil adapted to form a transformer when placed adjacent to the primary coil excited by an alternating-current to transfer energy through induction from the primary coil to said secondary coil to recharge said rechargeable energy source.

2. The reader of claim 1, wherein said rechargeable energy source is comprised from the group consisting of a battery and a capacitor.

3. The reader of claim 1, further comprising a remote communication module adapted to communicate information received from said communication electronics remotely.

4. The reader of claim 1, further comprising a network communication module adapted to communicate information received from said communication electronics over a network.

5. The reader of claim 1, wherein said alternating-current is a low frequency field.

6. The reader of claim 1, further comprising a control system that controls the energy from said secondary coil to said rechargeable energy source.

7. The reader of claim 6, wherein said control system recharges said rechargeable energy source when the energy from the secondary coil exceeds a threshold energy level.

8. The reader of claim 6, wherein said control system monitors said rechargeable energy source to determine if said energy source is fully charged.

9. A rechargeable interrogation reader that is adapted to recharge its energy source from a first plate of a capacitor, comprising:
a communication electronics;
a rechargeable energy source coupled to said communication electronics to provide power to said communication electronics; and
a second plate placed adjacent to the first plate to form a capacitor wherein the first plate is excited by an oscillating voltage to transfer energy through an electric field from the first plate to said second plate to recharge said rechargeable energy source.

10. The rechargeable interrogation reader of claim 9, further comprising a dielectric material placed in between the first plate and said second plate.

11. A cargo transportation system adapted to transport one or more objects having wireless communication devices that are interrogated by a rechargeable interrogation reader, comprising:
a static member attached to the transportation system;
a moveable member adapted to carry one or more objects that moves relative to said static member;
a primary coil attached to said static member;
a rechargeable interrogation reader having a rechargeable energy source wherein said interrogation reader is attached to said moveable member; and
a secondary coil mounted to said moveable member and coupled to said interrogation reader that is adapted to create a transformer to recharge said rechargeable energy source with energy from said secondary coil when said moveable member is positioned so that said secondary coil is in close proximity to said primary coil.

12. The system of claim 11, wherein said rechargeable energy source is comprised from the group consisting of a battery and a capacitor.

13. The system of claim 11, wherein said interrogation reader further comprises a remote communication module adapted to communicate information received from said communication electronics remotely.

14. The system of claim 11, wherein said interrogation reader further comprises a communication electronics and a network communication module adapted to communicate information received from said communication electronics over a network.

15. The system of claim 11, wherein said interrogation reader further comprises a control system that controls the energy from said secondary coil to said rechargeable energy source.

16. The system of claim 15, wherein said control system recharges said rechargeable energy source when the energy from the secondary coil exceeds a threshold energy level.

17. The system of claim 15, wherein said control system monitors said rechargeable energy source to determine if said energy source is fully charged.

18. The system of claim 11, wherein said static member is a static arm and said moveable member is a moveable arm.

19. The system of claim 11, wherein said interrogation reader is coupled to said secondary coil using a coaxial cable.

20. The system of claim 11, wherein said transportation system is comprised from the group consisting of a forklift truck and a crane.

21. The system of claim 11, further comprising a power signal that transfer energy to said primary coil when said secondary coil is located adjacent to said primary coil.

22. A cargo transportation system adapted to transport one or more objects having wireless communication devices that are interrogated by a rechargeable interrogation reader, comprising:
a static member attached to the transportation system;
a moveable member adapted to carry one or more objects that moves relative to said static member;
a first plate attached to said static member;
a rechargeable interrogation reader having a rechargeable energy source wherein said interrogation reader is attached to said moveable member; and
a second plate mounted to said moveable member and coupled to said interrogation reader that is adapted to create a capacitor to recharge said rechargeable energy source with energy from said second plate when said moveable member is positioned so that said second plate is in close proximity to said first plate.

23. The system of claim 22, further comprising a dielectric placed in between said first plate and said second plate.

24. The system of claim 22, further comprising a power signal that transfer energy to said first plate when said second plate is located adjacent to said first plate.

25. A method of recharging a rechargeable interrogation reader from a power source on a transportation system, comprising the steps of:
attaching a primary coil to a static member of the transportation system;
attaching a interrogation reader having a rechargeable energy source to a moveable member of the transportation system; and
attaching a secondary coil to said moveable member and coupling said secondary coil to said interrogation reader so that said primary coil and said secondary coil form a transformer for recharging said rechargeable energy source.

26. The method of claim 25, further comprising moving said moveable member so that said primary coil and said secondary coil are located adjacent each other to form said transformer.

27. The method of claim 25, further comprising controlling the energy from said secondary coil to recharge said rechargeable energy source.

28. The method of claim 27, further comprising decoupling said rechargeable energy source from said secondary coil when said rechargeable energy source is substantially fully charged.

29. The method of claim 27, further comprising decoupling said rechargeable energy source from said secondary coil when said rechargeable energy source contains energy above a threshold energy level.

30. The method of claim 25, further comprising raising said static member to decouple said secondary coil from said primary coil to discontinue recharging said rechargeable energy source.

31. The method of claim 25, further comprising lowering said static member to couple said secondary coil to said primary coil to form said transformer for recharging said rechargeable energy source.

32. A method of recharging a rechargeable interrogation reader from a power source on a transportation system, comprising the steps of:
attaching a first plate to a static member of the transportation system;
attaching an interrogation reader having a rechargeable energy source to a moveable member of the transportation system; and
attaching a second plate to said moveable member and coupling said second plate to said interrogation reader so that said first plate and said second plate form a capacitor for recharging said rechargeable energy source.

33. A method of using a rechargeable interrogation reader on a transportation system having a power source, comprising the steps of:
moving a moveable member on the transportation system containing a secondary coil relative to a static member on the transportation system having a primary coil; and
coupling said primary coil to said secondary coil to form a transformer for recharging a rechargeable energy source coupled to the rechargeable interrogation reader.

34. The method of claim 33, wherein said moving includes moving said moveable member so that said primary coil and said secondary coil are located directly adjacent to each other.

35. The method of claim 33, further comprising raising said static member relative to said moveable member to decouple said secondary coil from said primary coil to discontinue recharging said rechargeable energy source.

36. The method of claim 33, further comprising lowering said static member to couple said secondary coil to said primary coil to form said transformer for recharging said rechargeable energy source.

37. The method of claim 33, further comprising coupling a power signal to said primary coil when said moveable member is moved adjacent to said primary coil.

38. A method of using a rechargeable interrogation reader on a transportation system having a power source, comprising the steps of:
moving a moveable member on the transportation system containing a second plate relative to a static member on the transportation system having a first plate; and
coupling said first plate to said second plate to form a capacitor for recharging a rechargeable energy source coupled to the rechargeable interrogation reader.

39. The method of claim 38, further comprising coupling a power signal to said first plate when said moveable member is moved adjacent to said first plate.
